(19) United States
(12) Patent Application Publication
(10) Pub. No.: US 2021/0264198 A1
(43) Pub. Date: Aug. 26, 2021

(54) POSITIONING METHOD AND APPARATUS

(71) Applicant: Beijing Baidu Netcom Science and Technology Co., Ltd., Beijing (CN)

(72) Inventors: Jinchuan ZHANG, Beijing (CN); Chunyu SONG, Beijing (CN)

(21) Appl. No.: 17/249,203

(22) Filed: Feb. 23, 2021

(30) Foreign Application Priority Data
Feb. 25, 2020 (CN) 202010116634.9

(51) Int. Cl. G06K 9/62; G06K 9/46; G06F 16/583; G06F 16/532

(52) U.S. Cl. CPC G06K 9/6211; G06F 16/532; G06F 16/583; G06K 9/4609

(57) ABSTRACT

A positioning method and apparatus are provided. A specific embodiment of the method can include: acquiring description information of an object in an image to be positioned; searching in a database, based on the description information of the object in the image to be positioned, for preset images with description information matching the description information of the object in the image to be positioned, to obtain a set of preset images; matching the image to be positioned with the preset images in the set of preset images, to obtain an image matching the image to be positioned; and finally, determining a position of the image to be positioned based on preset position information corresponding to the image matching the image to be positioned.

### CROSS-REFERENCE TO RELATED APPLICATIONS

This application claims priority to Chinese Patent Application No. 202010116634.9, filed with the China National Intellectual Property Administration (CNIPA) on Feb. 25, 2020, the content of which is incorporated herein by reference in its entirety.

### TECHNICAL FIELD

Embodiments of the present disclosure relate to the field of computer technology, particularly to the field of computer vision technology, and more particularly to a positioning method and apparatus.

### BACKGROUND

Computer vision is a kind of simulation of biological vision using a computer and relevant devices, which processes a captured image or video to obtain three-dimensional information of a corresponding scenario.

A positioning method in relevant technologies matches a point feature extracted from a current image with point features of existing images in a database, and then positions the current image according to the positioning information of the existing image in the database that matches the current image in terms of the point feature.

### SUMMARY

Embodiments of the present disclosure provides a positioning method and apparatus.

In a first aspect, some embodiments of the present disclose provide a positioning method, the method includes: acquiring description information of an object in an image to be positioned; searching in a database, based on the description information of the object in the image to be positioned, for preset images with description information matching the description information of the object in the image to be positioned, to obtain a set of preset images; matching the image to be positioned with the preset images in the set of preset images, to obtain an image matching the image to be positioned; and determining a position of the image to be positioned based on preset position information corresponding to the image matching the image to be positioned.

In some embodiments, the matching the image to be positioned with the preset images in the set of preset images, to obtain the image matching the image to be positioned, includes: matching feature points of the image to be positioned with feature points of the preset images in the set of preset images, to obtain pairs of matching feature points; and performing verification on matching accuracies of the pairs of matching feature points, and determining a preset image corresponding to a pair of matching feature points with a matching accuracy greater than a threshold as the image matching the image to be positioned.

In some embodiments, the description information of the object in the image to be positioned comprises at least one of: description information of an iconic line segment in the image to be positioned, description information of a sign in the image to be positioned, or description information of a fixed object in the image to be positioned.

In some embodiments, the matching the image to be positioned with the preset images in the set of preset images, to obtain the image matching the image to be positioned includes: matching feature points of the image to be positioned with feature points of the preset images in the set of preset images, to obtain pairs of matching feature points; matching iconic line segments in the image to be positioned with iconic line segments in the preset images in the set of preset images, to obtain pairs of matching feature line segments; and performing verification on matching accuracies of the pairs of matching feature points and matching accuracies of the pairs of matching feature line segments respectively, and determining a preset image corresponding to a pair of matching feature points and a pair of matching feature line segments each with a matching accuracy greater than a set threshold thereof, as the image matching the image to be positioned.

In some embodiments, the matching the image to be positioned with the preset images in the set of preset images, to obtain an image matching the image to be positioned, includes: performing position filtering on the preset images in the set of preset images, to obtain a filtered set of preset images; and matching the image to be positioned with preset images in the filtered set of preset images, to obtain the image matching the image to be positioned.

In some embodiments, the method further includes: displaying the position information of the image to be positioned in a three-dimensional reconstructed image of an indoor environment.

In a second aspect, some embodiments of the present disclosure provide a positioning apparatus, the apparatus includes: an acquisition unit, configured to acquire description information of an object in an image to be positioned; a search unit, configured to search, based on the description information of the object in the image to be positioned, in a database for preset images with description information matching the description information of the object in the image to be positioned, to obtain a set of preset images; a matching unit, configured to match the image to be positioned with the preset images in the set of preset images, to obtain an image matching the image to be positioned; and a determination unit, configured to determine a position of the image to be positioned based on preset position information corresponding to the image matching the image to be positioned.

In some embodiments, the matching unit includes: a first matching module, configured to match feature points of the image to be positioned with feature points of the preset images in the set of preset images, to obtain pairs of matching feature points; and a first matching accuracy verification module, configured to determine a preset image corresponding to a pair of matching feature points with a matching accuracy greater than a threshold as the image matching the image to be positioned.

In some embodiments, the description information of the object in the image to be positioned comprises at least one of: description information of an iconic line segment in the image to be positioned, description information of a sign in the image to be positioned, or description information of a fixed object in the image to be positioned.

In some embodiments, the matching unit includes: a second matching module, configured to match feature points of the image to be positioned with feature points of the preset images in the set of preset images, to obtain pairs of matching feature points; a third matching module, configured to match iconic line segments in the image to be positioned with iconic line segments in the preset images in the set of preset images, to obtain pairs of matching feature line segments; and a second matching accuracy verification module, configured to perform verification on matching accuracies of the pairs of matching feature points and matching accuracies of the pairs of matching feature line segments respectively, and determine a preset image corresponding to a pair of matching feature points and a pair of matching feature line segments each with a matching accuracy greater than a set threshold thereof as the image matching the image to be positioned.

In some embodiments, the matching unit is further configured to: perform position filtering on the preset images in the set of preset images, to obtain a filtered set of preset images; and match the image to be positioned with preset images in the filtered set of preset images, to obtain the image matching the image to be positioned.

In some embodiments, the apparatus is further configured to: display the position information of the image to be positioned in a three-dimensional reconstructed image of an indoor environment.

In a third aspect, some embodiments of the present disclosure provide a server, the server includes: one or more processors; and a storage apparatus, storing one or more programs thereon, where the one or more programs, when executed by the one or more processors, cause the one or more processors to implement the method according to any one of embodiments of the first aspect.

In a fourth aspect, some embodiments of the present disclosure provide a computer-readable medium, storing a computer program thereon, where the program, when executed by a processor, causes the processor to implement the method according to any one of embodiments of the first aspect.

### BRIEF DESCRIPTION OF THE DRAWINGS

After reading detailed descriptions of non-limiting embodiments with reference to the following accompanying drawings, other features, objectives and advantages of the present disclosure will become more apparent.

FIG. 1 is a diagram of a system architecture to which embodiments of the present disclosure may be applied;

FIG. 2 is a flowchart of a positioning method according to an embodiment of the present disclosure;

FIG. 3 is a flowchart of a positioning method according to another embodiment of the present disclosure;

FIG. 4 is a schematic structural diagram of a positioning apparatus according to an embodiment of the present disclosure; and

FIG. 5 is a schematic structural diagram of a server adapted to implement embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

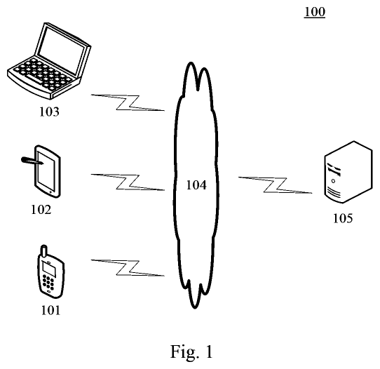

FIG. 1 shows a system architecture 100 to which a positioning method or a positioning apparatus according to embodiments of the present disclosure may be applied.

As shown in FIG. 1, the system architecture 100 may include a terminal device 101, 102, or 103, a network 104, and a server 105. The network 104 serves as a medium providing a communication link between the terminal device 101, 102, or 103 and the server 105. The network 104 may include various types of connections, such as wired or wireless communication links, or optical fiber cables.

A user may use the terminal device 101, 102, or 103 to interact with the server 105 through the network 104 to receive or send messages. The terminal device 101, 102, or 103 may be installed with various communication client applications, such as photo shoot applications, web browser applications, shopping applications, search applications, instant messaging tools, E-mail clients, and social platform software.

The terminal device 101, 102, or 103 may be hardware or software. When the terminal device 101, 102, or 103 is hardware, the terminal device may be various electronic devices having a display screen and supporting photo shoot, including but not limited to a smart phone, a tablet computer, an e-book reader, a laptop portable computer and a desktop computer. When the terminal device 101, 102, or 103 is software, the terminal device maybe installed in the above-listed electronic devices. The terminal device may be implemented as a plurality of software programs or software modules used to provide distributed services, or as a single software program or software module. Specific limitations are not given here.

The server 105 may be a server that provides various services, for example, an image server that processes images uploaded by the terminal device 101, 102, or 103. The image server may analyze the received data such as an image, and feed the processing result (such as the position of the image) back to the terminal device.

It should be noted that the positioning method provided by embodiments of the present disclosure maybe executed by the terminal device 101, 102, or 103, or by the server 105. Accordingly, the positioning apparatus may be arranged in the terminal device 101, 102, or 103, or in the server 105. Specific limitations are not given here.

It should be noted that the server or client may be hardware or software. When the server or client is hardware, it may be implemented as a distributed server cluster composed of a plurality of servers, or as a single server. When the server or client is software, it may be implemented as a plurality of software programs or software modules used to provide distributed services, or as a single software program or software module. Specific limitations are not given here. It should be understood that the numbers of the terminal devices, the network, and the server in FIG. 1 are merely illustrative. Any number of terminal devices, networks and servers may be configured according to actual requirements.

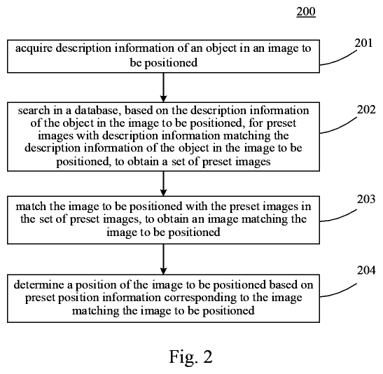

Continuing to refer to FIG. 2, a flow 200 of a positioning method according to an embodiment of the present disclosure is shown. The positioning method includes the following steps:

Step 201: acquiring description information of an object in an image to be positioned.

In an embodiment, the execution body (for example, the server shown in FIG. 1) of the positioning method may acquire the description information of the object in the image to be positioned locally or from a user side (for example, the terminal device shown in FIG. 1) in a wired connection manner or a wireless connection manner.

Particularly, the execution body may acquire the description information of the object in the image to be positioned locally or from an image database at the user side. Alternatively, the execution body first acquires the image to be positioned locally or from the user side, and then analyzes image features of the acquired image to be positioned to obtain the description information of the object in the image to be positioned.

In some optional implementations of the embodiment, the description information of the object in the image to be positioned may be one or more of: description information of an iconic line segment in the image to be positioned, description information of a sign in the image to be positioned, and description information of a fixed object in the image to be positioned.

The description information of the object in the image to be positioned may be description information corresponding to a fixed object in the image to be positioned, which is detected by the execution body or user side through an object detection technology, for example, category information of a fixed object such as “computer” or “fish tank”; or description information corresponding to an iconic line segment in the image to be positioned, which is detected by the execution body or user side through a deep learning method, such as “boundary line segment of Mr. Wang's office door”, where the iconic line segment is a non-dynamic line segment in the scenario, which may be a boundary of the door, a beam line or a pillar line; or description information corresponding to a sign in the image to be positioned, which is obtained by detecting, by the execution body or user side, identification information in the image to be positioned through an OCR technology, such as “identification information of a billboard” or “identification information of a traffic sign”.

Step 202: searching in a database, based on the description information of the object in the image to be positioned, for preset images with description information matching the description information of the object in the image to be positioned, to obtain a set of preset images.

In an embodiment, based on the description information of the object in the image to be positioned obtained in step 201, the execution body (for example, the server shown in FIG. 1) may search in a database for the preset images whose description information is the same as that of the object in the image to be positioned, to obtain the set of preset images.

As an example, if the image to be positioned contains description information “boundary line segment of Mr. Wang's office door” of an iconic line segment, the execution body searches in the database for the preset images whose description information is the same as the description information “boundary line segment of Mr. Wang's office door” of the iconic line segment, and determines all the images containing the description information “boundary line segment of Mr. Wang's office door” as the set of preset images; similarly, if the image to be positioned contains description information of a fixed object such as “computer” or “fish tank”, or description information of a sign such as “identification information of a billboard” or “identification information of a traffic sign”, the execution body searches in the database for the preset images whose description information is the same as that of the “computer”, “fish tank”, “identification information of a billboard”, or “identification information of a traffic sign”, and determines all the images containing the description information of the “computer”, “fish tank”, “identification information of a billboard”, or “identification information of a traffic sign” as the set of preset images.

Description information of a visually significant object, such as description information of an iconic line segment in the image to be positioned, description information of a sign in the image to be positioned, or description information of a fixed object in the image to be positioned is acquired, and then a database is searched therein for preset images whose description information is the same as that of the object in the image to be positioned to obtain a set of preset images. With the set of preset images determined based on the description information of the object in the image to be positioned, even if the image has regions with similar visual features (for example, the image contains repeated texture regions or weak texture regions), the image can be accurately positioned.

It should be noted that the method for determining the description information of the object in the preset image from the database is the same as the method for determining the description information of the object in the image to be positioned; and the object detection technology and the OCR technology are currently widely studied and applied known technologies, so details are not repeated herein again.

Step 203: matching the image to be positioned with the preset images in the set of preset images, to obtain an image matching the image to be positioned.

In an embodiment, the image matching the image to be positioned may be determined by means of matching feature points of the images, or the image matching the image to be positioned may also be determined by means of matching iconic line segments in the images.

In some optional implementations of the embodiment, feature points of the image to be positioned are matched with feature points of the preset images in the set of preset images to obtain pairs of matching feature points, then matching accuracies of the pairs of matching feature points are verified, and a preset image corresponding to a pair of matching feature points whose matching accuracy is greater than a threshold is determined as the image matching the image to be positioned. The matching accuracies of the pairs of matching feature points may be verified by means of determining pairs of points that accurate matching, such as verification on object geometric relationship or verification on distance between feature points. After the verification is performed on the matching accuracies, a pair of matching feature points that accurately matched are obtained, and a preset image corresponding to a number of pairs of matching feature points that accurately matched, the number being greater than a threshold, is determined as the image matching the image to be positioned.

In some optional implementations of the embodiment, position filtering may also be performed on the preset images in the set of preset images to remove a preset image which is far away from the image to be positioned, to obtain a filtered set of preset images, and then the image to be positioned is matched with the preset images in the filtered set of preset images to obtain the image matching the image to be positioned. By performing position filtering on the preset images in the set of preset images in advance and then matching the images after the position filtering, the obtained preset images in the set of preset images can be clearer, so that the image matching is more accurate and the positioning is more precise.

Step 204: determining a position of the image to be positioned based on preset position information corresponding to the image matching the image to be positioned.

In an embodiment, the preset position information corresponding to the image matching the image to be positioned is preset three-dimensional position information corresponding to the image matching the image to be positioned in the database, and the execution body determines the preset three-dimensional position information corresponding to the image matching the image to be positioned as the position of the image to be positioned.

As an example, during determining preset three-dimensional position information of preset images in an indoor environment, the indoor environment may be surrounded in advance by a vehicle-mounted or manually-carried camera, and then the execution body may acquire preset images that substantially cover the indoor environment, and then performs three-dimensional reconstruction on the preset images by means of sfm (Structure from Motion), to obtain reconstructed indoor environment images and real positions of the preset images in the indoor environment images.

In some optional implementations of the embodiment, after the position of the image to be positioned is determined in step 204, the position information of the image to be positioned may be further displayed in a three-dimensional reconstructed image of the indoor environment. The execution body (for example, the server 105 shown in FIG. 1) may mark the position information of the image to be positioned in the form of an identifier (such as an arrow, or a dot) in the three-dimensional reconstructed image of the indoor environment, which can then be sent to the user side for display.

According to the method provided by the above embodiment of the present disclosure, description information of an object in an image to be positioned is first acquired; based on the description information of the object in the image to be positioned, a database is searched therein for preset images whose description information matches the description information of the object in the image to be positioned, to obtain a set of preset images; then feature points of the image to be positioned are matched with feature points of the preset images in the set of preset images, to obtain pairs of matching feature points; verification is performed on the matching accuracies of the pairs of matching feature points, and the preset image corresponding to a pair of matching feature points whose matching accuracy is greater than a threshold is determined as an image matching the image to be positioned; and finally, a position of the image to be positioned is determined based on the preset position information corresponding to the image matching the image to be positioned, so that the positioning is more accurate.

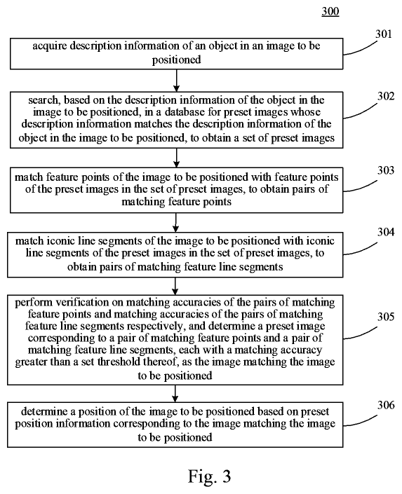

Further referring to FIG. 3, a flow 300 of a positioning method according to another embodiment is shown. The flow 300 of the positioning method includes the following steps:

Step 301: acquiring description information of an object in an image to be positioned.

In an embodiment, the execution body (for example, the server shown in FIG. 1) of the positioning method may receive the description information of the object in the image to be positioned from a user side in a wired connection manner or a wireless connection manner, where the description information is analyzed by the user side (for example, the terminal device shown in FIG. 1) in advance, or the execution body of the positioning method receives the image to be positioned, which is captured by a user side or stored in a local image library of the user side, from the user side in a wired connection manner or a wireless connection manner, and then analyze the received image to be positioned to obtain the description information of the object in the image to be positioned.

In some optional implementations of the embodiment, the description information of the object in the image to be positioned may be one or more of: description information of an iconic line segment in the image to be positioned, description information of a sign in the image to be positioned, and description information of a fixed object in the image to be positioned.

The execution body or user side analyzes the image to be positioned to obtain description information of the object in the image to be positioned may include detecting a fixed object in the image to be positioned through an object detection technology, and acquiring description information corresponding to the fixed object in the image to be positioned, for example, category information of a fixed object such as “computer” or “fish tank”; or description information corresponding to an iconic line segment in the image to be positioned, which is detected through the object detection technology, such as “boundary line segment of Mr. Wang's office door”; or description information corresponding to a sign in the image to be positioned, which is obtained by detecting identification information in the image to be positioned through an OCR technology, such as “identification information of a billboard” or “identification information of a traffic sign”.

Step 302: searching, based on the description information of the object in the image to be positioned, in a database for preset images whose description information matches the description information of the object in the image to be positioned, to obtain a set of preset images.

In an embodiment, based on the description information of the object in the image to be positioned obtained in step 301, the execution body (for example, the server shown in FIG. 1) may search in the database for the preset images whose description information is the same as that of the object in the image to be positioned, to obtain the set of preset images.

As an example, if the image to be positioned contains description information “boundary line segment of Mr. Wang's office door” of an iconic line segment, the execution body searches in the database for the preset images whose description information is the same as the description information “boundary line segment of Mr. Wang's office door” of the iconic line segment, and determines all the images containing the description information “boundary line segment of Mr. Wang's office door” as the set of preset images; similarly, if the image to be positioned contains description information of a fixed object such as “computer” or “fish tank”, or description information of a sign such as “identification information of a billboard” or “identification information of a traffic sign”, the execution body searches in the database for the preset images whose description information is the same as that of the “computer”, “fish tank”, “identification information of a billboard”, or “identification information of a traffic sign”, and determines all the images containing the description information of the “computer”, “fish tank”, “identification information of a billboard”, or “identification information of a traffic sign” as the set of preset images.

Description information of a visually significant object, such as description information of an iconic line segment in the image to be positioned, description information of a sign in the image to be positioned, or description information of a fixed object in the image to be positioned is acquired, and then a database is searched therein for preset images whose description information is the same as that of the object in the image to be positioned to obtain a set of preset images, so that even if the image contains repeated texture regions or weak texture regions, accurate positioning can be achieved.

Step 303: matching feature points of the image to be positioned with feature points of the preset images in the set of preset images, to obtain pairs of matching feature points.

In an embodiment, the feature points of the image to be positioned may be detected by a detection algorithm, may be detected based on a deep learning method, or may be manually marked points in a scenario.

During matching two feature points, a feature point of the image to be positioned may be matched with a feature point of the preset image in the set of preset images by distance measuring (for example, Euclidean distance measurement) or by setting matching strategy (for example, the ratio of the nearest neighbor distance to the second nearest neighbor distance is smaller than a set value).

Step 304: matching iconic line segments of the image to be positioned with iconic line segments of the preset images in the set of preset images, to obtain pairs of matching feature line segments.

In an embodiment, the iconic line segments of the image to be positioned may be detected by a detection algorithm, may be detected based on a deep learning method, or may be manually marked iconic line segments in a scenario.

During matching two iconic line segments, the iconic line segment of the image to be positioned may be matched with the iconic line segment of the preset image in the set of preset images by means of distance measure (for example, Euclidean distance measurement) or by setting a matching strategy (for example, the ratio of the nearest neighbor distance to the second nearest neighbor distance is smaller than a set value).

In some optional implementations of the embodiment, position filtering may be performed in advance on the preset images in the set of preset images to obtain a filtered set of preset images, and then the feature points of the image to be positioned are matched with the feature points of the preset images in the set of preset images to obtain pairs of matching feature points; and the iconic line segments of the image to be positioned are matched with the iconic line segments of the preset images in the set of preset images, to obtain pairs of matching feature line segments. By performing position filtering on the preset images in the set of preset images in advance, the preset images in the set of preset images may be clearer, the matching of the feature points and the matching of the iconic line segments can be more accurate, and the positioning is ultimately more precise.

Step 305: performing verification on matching accuracies of the pairs of matching feature points and matching accuracies of the pairs of matching feature line segments respectively, and determining a preset image corresponding to a pair of matching feature points and a pair of matching feature line segments each with a matching accuracy greater than a set threshold thereof, as the image matching the image to be positioned.

In an embodiment, the matching accuracy of a pair of matching feature points may be verified by means of verifying whether the pair of matching points match accurately, such as verification on object geometric relationship or verification on distance between feature points; and the matching accuracy of a pair of matching feature line segments may be verified by means of verifying whether the pair of matching line segments match accurately, such as verification on object geometric relationship.

After the verification is performed on the matching accuracies, the execution body obtains a pair of matching feature points and a pair of matching feature line segments that accurately matched. Next, the execution body determines whether the number of the pairs of matching feature points that accurately matched is greater than a preset first threshold, determines whether the number of the pairs of matching feature line segments that accurately matched is greater than a preset second threshold, and then determines the preset image with number of the pairs of matching feature points being greater than the preset first threshold and the number of the pairs of matching feature line segments that accurately matched being greater than the preset second threshold, as the image matching the image to be positioned.

Step 306: determining a position of the image to be positioned based on preset position information corresponding to the image matching the image to be positioned.

In an embodiment, the preset position information corresponding to the image matching the image to be positioned is preset three-dimensional position information corresponding to the image matching the image to be positioned in the database, and the execution body determines the preset three-dimensional position information corresponding to the image matching the image to be positioned as the position of the image to be positioned.

As an example, during determining preset three-dimensional position information of preset images in an indoor environment, the indoor environment may be surrounded in advance by a vehicle-mounted or manually-carried camera, and then the execution body may acquire preset images that substantially cover the indoor environment, and then performs three-dimensional reconstruction on the preset images by means of sfm (Structure from Motion), to obtain reconstructed indoor environment images and real positions of the preset images in the indoor environment images.

In some optional implementations of the embodiment, after the position of the image to be positioned is determined in step 204, the position information of the image to be positioned may be further displayed in a three-dimensional reconstructed image of the indoor environment. The execution body (for example, the server 105 shown in FIG. 1) may mark the position information of the image to be positioned in the form of an identifier (such as an arrow, or a dot) in the three-dimensional reconstructed image of the indoor environment, which can then be sent to the user side for display.

According to the method provided by the above embodiment of the present disclosure, description information of an object in an image to be positioned is first acquired; based on the description information of the object in the image to be positioned, a database is searched therein for preset images whose description information matches the description information of the object in the image to be positioned, to obtain a set of preset images; then feature points of the image to be positioned are matched with feature points of the preset images in the set of preset images, to obtain pairs of matching feature points; iconic line segments of the image to be positioned are matched with iconic line segments of the preset images in the set of preset images, to obtain pairs of matching feature line segments; verification is performed on the matching accuracies of the pairs of matching feature points and the matching accuracies of the pairs of matching feature line segments, and the preset image corresponding to a pair of matching feature points and a pair of matching line segments each with a matching accuracy greater than a set threshold thereof is determined as the image matching the image to be positioned; and a position of the image to be positioned is determined based on preset position information corresponding to the image matching the image to be positioned, so that the accuracy of image matching is increased and accurate positioning can be achieved.

It should be noted that the method for determining the description information of the object in the preset image from the database is the same as the method for determining the description information of the object in the image to be positioned; and the object detection technology and the OCR technology are currently widely studied and applied known technologies, so details are not repeated herein again.

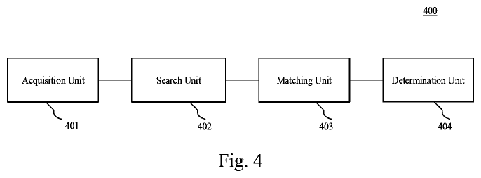

Further referring to FIG. 4, as an implementation of the method shown in the above figures, the present disclosure provides an embodiment of a positioning apparatus. Embodiments of the apparatus corresponds to embodiments of the method shown in FIG. 2, and the apparatus may be applied to various electronic devices.

As shown in FIG. 4, the positioning apparatus 400 of this embodiment includes: an acquisition unit 401, a search unit 402, a matching unit 403, and a determination unit 404. The acquisition unit 401 is configured to acquire description information of an object in an image to be positioned; the search unit 402 is configured to search, based on the description information of the object in the image to be positioned, in a database for preset images with description information matching the description information of the object in the image to be positioned, to obtain a set of preset images; the matching unit 403 is configured to match the image to be positioned with the preset images in the set of preset images, to obtain an image matching the image to be positioned; and the determination unit 404 is configured to determine a position of the image to be positioned based on preset position information corresponding to the image matching the image to be positioned.

In some optional implementations of the embodiment, the description information of the object in the image to be positioned includes at least one of: description information of an iconic line segment in the image to be positioned, description information of a sign in the image to be positioned, or description information of a fixed object in the image to be positioned.

In some optional implementations of the embodiment, the matching unit 403 may be configured to match feature points of the image to be positioned with feature points of the preset images in the set of preset images, to obtain pairs of matching feature points; and determine a preset image corresponding to a pair of matching feature points with a matching accuracy greater than a threshold as the image matching the image to be positioned.

In some optional implementations of the embodiment, the matching unit 403 of the positioning apparatus 400 may further be configured to match feature points of the image to be positioned with feature points of the preset images in the set of preset images, to obtain pairs of matching feature points; match iconic line segments in the image to be positioned with iconic line segments in the preset images in the set of preset images, to obtain pairs of matching feature line segments; and perform verification on matching accuracies of the pairs of matching feature points and matching accuracies of the pairs of matching feature line segments respectively, and determine a preset image corresponding to a pair of matching feature points and a pair of matching feature line segments each with a matching accuracy greater than a set threshold thereof as the image matching the image to be positioned.

In some optional implementations of the embodiment, the matching unit 403 of the positioning apparatus 400 is further configured to perform position filtering on the preset images in the set of preset images, to obtain a filtered set of preset images; and then match the image to be positioned with preset images in the filtered set of preset images, to obtain the image matching the image to be positioned.

In some optional implementations of the embodiment, the positioning apparatus 400 is further configured to display the position information of the image to be positioned in a three-dimensional reconstructed image of an indoor environment.

It should be understood that each unit recorded in the apparatus 400 corresponds to each step recorded in the methods described with reference to FIGS. 2 and 3. Therefore, the operations and features described above for the methods are also applicable to the apparatus 400 and the units included therein, and details are not described herein again.

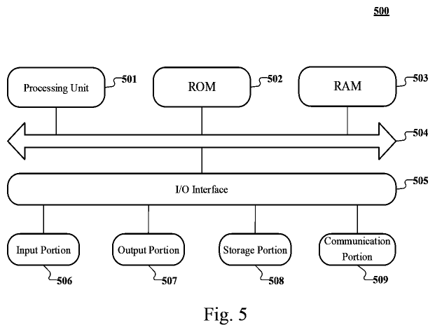

Referring to FIG. 5, a schematic structural diagram of a computer system 500 adapted to implement a server/electronic device of embodiments of the present disclosure is shown. The server shown in FIG. 5 is just an example, and should no bring any limitation to the function and usage range of embodiments of the prenset disclosure.

As shown in FIG. 5, the computer system 500 includes processing unit (such as a central processing unit, CPU) 501, which may execute various appropriate actions and processes in accordance with a program stored in a read-only memory (ROM) 502 or a program loaded into a random access memory (RAM) 503 from a storage portion 508. The RAM 503 also stores various programs and data required by operations of the system 500. The processing unit 501, the ROM 502 and the RAM 503 are connected to each other through a bus 504. An input/output (I/O) interface 505 is also connected to the bus 504.

The following components are connected to the I/O interface 505: an input portion 506 including a touch screen, a touch pad, a keyboard, a mouse, a camera, a microphone, an accelerometer and a gyroscope etc.; an output portion 507 comprising a liquid crystal display device (LCD), a speaker, a vibrator etc.; a storage portion 508 including a magnetic tape, a hard disk and the like; and a communication portion 509. The communication portion 509 allows server/electronic device 500 to communicate wirelessly or wirelessly with other devices to exchange data. Although FIG. 5 shows server/electronic device 500 with a variety of portions, it should be understood that the implementation or possession of all the portions shown is not required. More or fewer portions may be implemented or available alternatively. Each of the boxes shown in FIG. 5 can represent one portion or as many portions as needed.

In particular, according to embodiments of the present disclosure, the process described above with reference to the flow chart may be implemented in a computer software program. For example, an embodiment of the present disclosure includes a computer program product, which comprises a computer program that is hosted in a machine-readable medium. The computer program comprises program codes for executing the method as illustrated in the flow chart. In such an embodiment, the computer program may be downloaded and installed from a network via the communication portion 509, or maybe installed from the storgae portion 508, or may be installed from the ROM 502. The computer program, when executed by the processing unit (CPU) 501, implements the above mentioned functionalities as defined by the methods of some embodiments of the present disclosure. It should be noted that the computer readable medium in some embodiments of the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In some embodiments of the present disclosure, the computer readable storage medium may be any tangible medium containing or storing programs which can be used by a command execution system, apparatus or element or incorporated thereto. In some embodiments of the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The above computer-readable medium may be contained in the above server/electronic device; It may also exist on its own and not be assembled into the server/electronic device. The computer readable medium carries one or more programs. When the one or more programs are executed by the server/electronic device, the server/electronic device is enabled to: acquire description information of an object in an image to be positioned; search in a database, based on the description information of the object in the image to be positioned, for preset images with description information matching the description information of the object in the image to be positioned, to obtain a set of preset images; match the image to be positioned with the preset images in the set of preset images, to obtain an image matching the image to be positioned; and determine a position of the image to be positioned based on preset position information corresponding to the image matching the image to be positioned.

A computer program code for executing operations in some embodiments of the present disclosure maybe compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units or modules involved in the embodiments of the present disclosure may be implemented by means of software or hardware. The described units or modules may also be provided in a processor, for example, described as: a processor, comprising an acquisition unit, a search unit, a matching unit, and a determination unit, where the names of these units or modules do not in some cases constitute a limitation to such units or modules themselves. For example, the acquisition unit may also be described as “a unit for acquiring description information of an object in an image to be positioned.”

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A positioning method, comprising:
acquiring description information of an object in an image to be positioned;
searching in a database, based on the description information of the object in the image to be positioned, for preset images with description information matching the description information of the object in the image to be positioned, to obtain a set of preset images;
matching the image to be positioned with the preset images in the set of preset images, to obtain an image matching the image to be positioned; and
determining a position of the image to be positioned based on preset position information corresponding to the image matching the image to be positioned.

2. The positioning method according to claim 1, wherein matching the image to be positioned with the preset images in the set of preset images, to obtain the image matching the image to be positioned, comprises:
matching feature points of the image to be positioned with feature points of the preset images in the set of preset images, to obtain pairs of matching feature points; and
performing verification on matching accuracies of the pairs of matching feature points, and determining a preset image corresponding to a pair of matching feature points with a matching accuracy greater than a threshold as the image matching the image to be positioned.

3. The positioning method according to claim 1, wherein the description information of the object in the image to be positioned comprises at least one of: description information of an iconic line segment in the image to be positioned, description information of a sign in the image to be positioned, or description information of a fixed object in the image to be positioned.

4. The positioning method according to claim 3, wherein matching the image to be positioned with the preset images in the set of preset images, to obtain the image matching the image to be positioned comprises:
matching feature points of the image to be positioned with feature points of the preset images in the set of preset images, to obtain pairs of matching feature points;
matching iconic line segments in the image to be positioned with iconic line segments in the preset images in the set of preset images, to obtain pairs of matching feature line segments; and
performing verification on matching accuracies of the pairs of matching feature points and matching accuracies of the pairs of matching feature line segments respectively, and determining a preset image corresponding to a pair of matching feature points and a pair of matching feature line segments each with a matching accuracy greater than a set threshold thereof, as the image matching the image to be positioned.

5. The positioning method according to claim 1, wherein matching the image to be positioned with the preset images in the set of preset images, to obtain an image matching the image to be positioned, comprises:
performing position filtering on the preset images in the set of preset images, to obtain a filtered set of preset images; and
matching the image to be positioned with preset images in the filtered set of preset images, to obtain the image matching the image to be positioned.

6. The positioning method according to claim 1, wherein the method further comprises:
displaying the position information of the image to be positioned in a three-dimensional reconstructed image of an indoor environment.

7. A server, comprising:
one or more processors; and
a storage storing one or more programs thereon,
wherein the one or more programs, when executed by the one or more processors, cause the one or more processors to implement operations comprising:
acquiring description information of an object in an image to be positioned;
searching in a database, based on the description information of the object in the image to be positioned, for preset images with description information matching the description information of the object in the image to be positioned, to obtain a set of preset images;
matching the image to be positioned with the preset images in the set of preset images, to obtain an image matching the image to be positioned; and
determining a position of the image to be positioned based on preset position information corresponding to the image matching the image to be positioned.

8. The server according to claim 7, wherein matching the image to be positioned with the preset images in the set of preset images, to obtain the image matching the image to be positioned, comprises:
matching feature points of the image to be positioned with feature points of the preset images in the set of preset images, to obtain pairs of matching feature points; and
performing verification on matching accuracies of the pairs of matching feature points, and determining a preset image corresponding to a pair of matching feature points with a matching accuracy greater than a threshold as the image matching the image to be positioned.

9. The server according to claim 7, wherein the description information of the object in the image to be positioned comprises at least one of: description information of an iconic line segment in the image to be positioned, description information of a sign in the image to be positioned, or description information of a fixed object in the image to be positioned.

10. The server according to claim 9, wherein matching the image to be positioned with the preset images in the set of preset images, to obtain the image matching the image to be positioned comprises:
matching feature points of the image to be positioned with feature points of the preset images in the set of preset images, to obtain pairs of matching feature points;
matching iconic line segments in the image to be positioned with iconic line segments in the preset images in the set of preset images, to obtain pairs of matching feature line segments; and
performing verification on matching accuracies of the pairs of matching feature points and matching accuracies of the pairs of matching feature line segments respectively, and determining a preset image corresponding to a pair of matching feature points and a pair of matching feature line segments each with a matching accuracy greater than a set threshold thereof, as the image matching the image to be positioned.

11. The server according to claim 7, wherein matching the image to be positioned with the preset images in the set of preset images, to obtain an image matching the image to be positioned, comprises:
performing position filtering on the preset images in the set of preset images, to obtain a filtered set of preset images; and
matching the image to be positioned with preset images in the filtered set of preset images, to obtain the image matching the image to be positioned.

12. The server according to claim 7, wherein the operations further include:
displaying the position information of the image to be positioned in a three-dimensional reconstructed image of an indoor environment.

13. A non-transitory computer-readable medium, storing a computer program thereon, wherein the program, when executed by a processor, causes the processor to implement operations comprising:
acquiring description information of an object in an image to be positioned;
searching in a database, based on the description information of the object in the image to be positioned, for preset images with description information matching the description information of the object in the image to be positioned, to obtain a set of preset images;
matching the image to be positioned with the preset images in the set of preset images, to obtain an image matching the image to be positioned; and
determining a position of the image to be positioned based on preset position information corresponding to the image matching the image to be positioned.

14. The medium according to claim 13, wherein matching the image to be positioned with the preset images in the set of preset images, to obtain the image matching the image to be positioned, comprises:
matching feature points of the image to be positioned with feature points of the preset images in the set of preset images, to obtain pairs of matching feature points; and
performing verification on matching accuracies of the pairs of matching feature points, and determining a preset image corresponding to a pair of matching feature points with a matching accuracy greater than a threshold as the image matching the image to be positioned.

15. The medium according to claim 13, wherein the description information of the object in the image to be positioned comprises at least one of: description information of an iconic line segment in the image to be positioned, description information of a sign in the image to be positioned, or description information of a fixed object in the image to be positioned.

16. The medium according to claim 15, wherein matching the image to be positioned with the preset images in the set of preset images, to obtain the image matching the image to be positioned comprises:
matching feature points of the image to be positioned with feature points of the preset images in the set of preset images, to obtain pairs of matching feature points;
matching iconic line segments in the image to be positioned with iconic line segments in the preset images in the set of preset images, to obtain pairs of matching feature line segments; and
performing verification on matching accuracies of the pairs of matching feature points and matching accuracies of the pairs of matching feature line segments respectively, and determining a preset image corresponding to a pair of matching feature points and a pair of matching feature line segments each with a matching accuracy greater than a set threshold thereof, as the image matching the image to be positioned.

17. The medium according to claim 13, wherein matching the image to be positioned with the preset images in the set of preset images, to obtain an image matching the image to be positioned, comprises:
performing position filtering on the preset images in the set of preset images, to obtain a filtered set of preset images; and
matching the image to be positioned with preset images in the filtered set of preset images, to obtain the image matching the image to be positioned.

18. The medium according to claim 13, wherein the operations further comprise:
displaying the position information of the image to be positioned in a three-dimensional reconstructed image of an indoor environment.
